(19) United States
(12) Patent Application Publication
(10) Pub. No.: US 2025/0056008 A1
(43) Pub. Date: Feb. 13, 2025

(54) MULTI-MODEL CROSS-COMPONENT LINEAR MODEL PREDICTION

(71) Applicant: MEDIATEK INC., Hsinchu City (TW)

(72) Inventors: Yu-Ling HSIAO, Hsinchu City (TW); Olena CHUBACH, San Jose, CA (US); Chun-Chia CHEN, Hsinchu City (TW); Chia-Ming TSAI, Hsinchu City (TW); Man-Shu CHIANG, Hsinchu City (TW); Chih-Wei HSU, Hsinchu City (TW); Tzu-Der CHUANG, Hsinchu City (TW); Ching-Yeh CHEN, Hsinchu City (TW); Yu-Wen HUANG, Hsinchu City (TW)

(21) Appl. No.: 18/720,890

(22) PCT Filed: Dec. 20, 2022
(86) PCT No.: PCT/CN2022/140402

§ 371 Date: Jun. 17, 2024

Related U.S. Application Data
(60) Provisional application No. 63/291,996, filed on Dec. 21, 2021.

(51) Int. Cl. H04N 19/159; H04N 19/132; H04N 19/176; H04N 19/186

(52) U.S. Cl. CPC H04N 19/159; H04N 19/132; H04N 19/176; H04N 19/186

(57) ABSTRACT

A video coding system that uses multiple models to predict chroma samples is provided. The video coding system receives data for a block of pixels to be encoded or decoded as a current block of a current picture of a video. The system constructs two or more chroma prediction models based on luma and chroma samples neighboring the current block. The system applies the two or more chroma prediction models to incoming or reconstructed luma samples of the current block to produce two or more model predictions. The system computes predicted chroma samples by combining the two or more model predictions. The system uses the predicted chroma samples to reconstruct chroma samples of the current block or to encode the current block.

### CROSS REFERENCE TO RELATED PATENT APPLICATION(S)

The present disclosure is part of a non-provisional application that claims the priority benefit of U.S. Provisional Patent Application No. 63/291,996, filed on 21 Dec. 2021. Content of above-listed application is herein incorporated by reference.

### TECHNICAL FIELD

The present disclosure relates generally to video coding. In particular, the present disclosure relates to cross-component linear model prediction.

### BACKGROUND

Unless otherwise indicated herein, approaches described in this section are not prior art to the claims listed below and are not admitted as prior art by inclusion in this section.

High-Efficiency Video Coding (HEVC) is an international video coding standard developed by the Joint Collaborative Team on Video Coding (JCT-VC). HEVC is based on the hybrid block-based motion-compensated DCT-like transform coding architecture. The basic unit for compression, termed coding unit (CU), is a 2N×2N square block of pixels, and each CU can be recursively split into four smaller CUs until the predefined minimum size is reached. Each CU contains one or multiple prediction units (PUs).

Versatile Video Coding (VVC) is a codec designed to meet upcoming needs in videoconferencing, over-the-top streaming, mobile telephony, etc. VVC is meant to be very versatile and address all the video needs from low resolution and low bitrates to high resolution and high bitrates, high dynamic range (HDR), 360 omnidirectional, etc. VVC supports YCbCr color spaces with 4:2:0 sampling, 10 bits per component, YCbCr/RGB 4:4:4 and YCbCr 4:2:2, with bit depths up to 16 bits per component, with HDR and wide-gamut color, along with auxiliary channels for transparency, depth, and more.

### SUMMARY

The following summary is illustrative only and is not intended to be limiting in any way. That is, the following summary is provided to introduce concepts, highlights, benefits and advantages of the novel and non-obvious techniques described herein. Select and not all implementations are further described below in the detailed description. Thus, the following summary is not intended to identify essential features of the claimed subject matter, nor is it intended for use in determining the scope of the claimed subject matter.

Some embodiments of the disclosure provide a video coding system that uses multiple models to predict chroma samples. The video coding system receives data for a block of pixels to be encoded or decoded as a current block of a current picture of a video. The system constructs two or more chroma prediction models based on luma and chroma samples neighboring the current block. The system applies the two or more chroma prediction models to incoming or reconstructed luma samples of the current block to produce two or more model predictions. The system computes predicted chroma samples by combining the two or more model predictions. The system uses the predicted chroma samples to reconstruct chroma samples of the current block or to encode the current block.

The two or more chroma prediction models may include a LM-T model that is derived based on neighboring reconstructed luma samples above the current block, a LM-L model that is derived based on neighboring reconstructed luma samples left of the current block, and a LM-LT model that is derived based on neighboring reconstructed luma samples above the current block and left of the current block. In some embodiments, the two or more chroma prediction models includes multiple LM-T models and/or multiple LM-L models.

The predicted chroma samples may be computed as a weighted sum of the two or more model predictions. In some embodiments, each of the two or more model predictions is weighted based on a position of the predicted sample (or current sample) in the current block. In some embodiments, the two or more model predictions are weighted according to distances from the predicted sample to top and left boundaries of the current block. In some embodiments, the two or more model predictions are weighted according to corresponding two or more weighting factors. In some embodiments, each of the two or more model predictions is weighted based on a similarity measure between boundary samples of the current block and reconstructed neighboring samples of the current block.

In some embodiments, the predicted chroma samples in different regions of the current block may be computed by different fusion methods. For example, the corresponding two or more weighting factors may be assigned different values in different regions of the current block. The predicted chroma samples in different regions of the current block may be computed by different sets of linear models.

In some embodiments, the predicted chroma samples is computed by further combining inter-prediction or intra-prediction of the current block with the two or more model predictions produced by the two or more chroma prediction models.

### BRIEF DESCRIPTION OF THE DRAWINGS

The accompanying drawings are included to provide a further understanding of the present disclosure, and are incorporated in and constitute a part of the present disclosure. The drawings illustrate implementations of the present disclosure and, together with the description, serve to explain the principles of the present disclosure. It is appreciable that the drawings are not necessarily in scale as some components may be shown to be out of proportion than the size in actual implementation in order to clearly illustrate the concept of the present disclosure.

FIG. 1 shows the locations of the left and above samples and the samples of the current block that are involved in cross-component linear model (CCLM) mode.

FIG. 2 conceptually illustrates multi-model chroma prediction for a block of pixels.

FIG. 3 conceptually illustrates the construction of chroma prediction linear models for the three CCLM modes.

FIG. 4 conceptually illustrates distances to the top and the left from a position in the current block.

FIG. 5 conceptually illustrates multi-model chroma prediction with multiple LM-T and/or multiple LM-L models.

FIGS. 6A-C conceptually illustrate using multiple linear models for chroma prediction based on the positions of the predicted samples.

FIG. 7 illustrates an example video encoder that may implement chroma prediction.

FIG. 8 illustrates portions of the video encoder that implement multi-model chroma prediction.

FIG. 9 conceptually illustrates a process for using multi-model chroma prediction to encode a block of pixels.

FIG. 10 illustrates an example video decoder that may implement chroma prediction.

FIG. 11 illustrates portions of the video decoder that implement multi-model chroma prediction.

FIG. 12 conceptually illustrates a process for using multi-model chroma prediction to decode a block of pixels.

FIG. 13 conceptually illustrates an electronic system with which some embodiments of the present disclosure are implemented.

### DETAILED DESCRIPTION

In the following detailed description, numerous specific details are set forth by way of examples in order to provide a thorough understanding of the relevant teachings. Any variations, derivatives and/or extensions based on teachings described herein are within the protective scope of the present disclosure. In some instances, well-known methods, procedures, components, and/or circuitry pertaining to one or more example implementations disclosed herein may be described at a relatively high level without detail, in order to avoid unnecessarily obscuring aspects of teachings of the present disclosure.

### I. Cross Component Linear Model (CCLM)

Cross Component Linear Model (CCLM) or Linear Model (LM) mode is a chroma prediction mode in which chroma components of a block is predicted from the collocated reconstructed luma samples by linear models. The parameters (e.g., scale and offset) of the linear model are derived from already reconstructed luma and chroma samples that are adjacent to the block. For example, in VVC, the CCLM mode makes use of inter-channel dependencies to predict the chroma samples from reconstructed luma samples. This prediction is carried out using a linear model in the form of:

$$P ( i , j ) = α \cdot {rec}_{L}^{′} ( i , j ) + β \qquad eq . ( 1 )$$

P(i,j) in eq. (1) represents the predicted chroma samples in a CU (or the predicted chroma samples of the current CU) and rec_{L}′(i,j) represents the down-sampled reconstructed luma samples of the same CU (or the corresponding reconstructed luma samples of the current CU).

The CCLM model parameters α (scaling parameter) and β (offset parameter) are derived based on at most four neighboring chroma samples and their corresponding down-sampled luma samples. In LM_A mode (also denoted as LM-T mode), only the above or top-neighboring template is used to calculate the linear model coefficients. In LM_L mode (also denoted as LM-L mode), only left template is used to calculate the linear model coefficients. In LM-LA mode (also denoted as LM-LT mode), both left and above templates are used to calculate the linear model coefficients.

Suppose the current chroma block dimensions are W×H, then W′ and H′ are set as
W′=W, H′=H when LM-LT mode is applied;
W′=W+H when LM-T mode is applied;
H′=H+W when LM-L mode is applied

The above neighboring positions are denoted as S[0, −1] . . . S[W′−1, −1] and the left neighboring positions are denoted as S[−1, 0] . . . S[−1, H′−1]. Then the four samples are selected as
S[W′/4, −1], S[3*W′/4, −1], S[−1, H′/4], S[−1, 3*H′/4] when LM mode is applied (both above and left neighboring samples are available);
S[W′/8, −1], S[3*W′/8, −1], S[5*W′/8, −1], S[7*W′/8, −1] when LM-T mode is applied (only the above neighboring samples are available);
S[−1, H′/8],S[−1,3*H′/8],S[−1,5*H′/8],S[−1,7*H′/8] when LM-Lmode is applied (only the left neighboring samples are available);

The four neighboring luma samples at the selected positions are down-sampled and compared four times to find two larger values: x⁰_{A} and x¹_{A}, and two smaller values: x⁰_{B} and x¹_{B}. Their corresponding chroma sample values are denoted as y⁰_{A}, y¹_{A}, y⁰_{B} and y¹_{B}. Then X_{A}, X_{B}, Y_{A} and Y_{B} are derived as:

$${X}_{a} = ( {x}_{A}^{0} + {x}_{A}^{1} + 1 ) ≫ 1 ; {X}_{b} = ( {x}_{B}^{0} + {x}_{B}^{1} + 1 ) ≫ 1 ; \qquad eq . ( 2 )$$

$${Y}_{a} = ( {y}_{A}^{0} + {y}_{A}^{1} + 1 ) ≫ 1 ; {Y}_{b} = ( {y}_{B}^{0} + {y}_{B}^{1} + 1 ) ≫ 1 \qquad eq . ( 3 )$$

The linear model parameters α and β are obtained according to the following equations

$$α = \frac{{Y}_{a} - {Y}_{b}}{{X}_{a} - {X}_{b}} \qquad eq . ( 4 )$$

$$β = {Y}_{b} - α \cdot {X}_{b} \qquad eq . ( 5 )$$

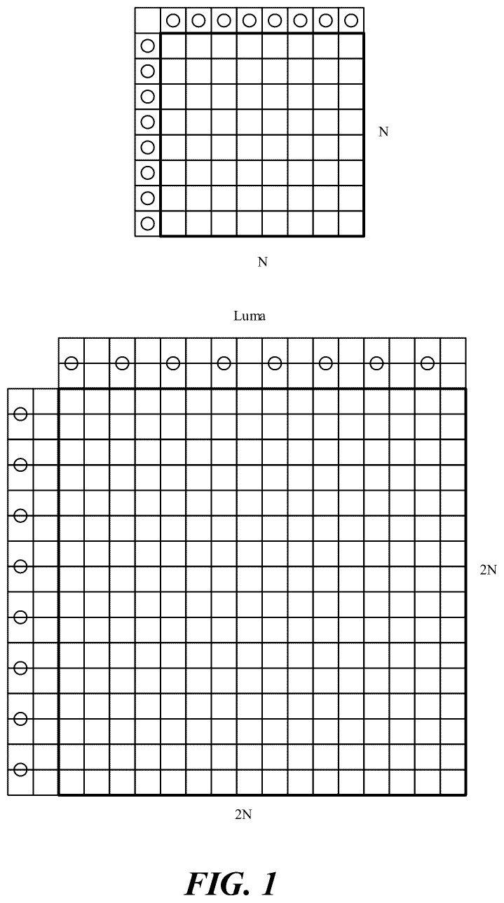

FIG. 1 shows the locations of the left and above samples and the samples of the current block that are involved in CCLM mode. In other words, the figure shows the locations of the samples that are used to derive the α and β parameters.

The operations to calculate the α and β parameters according to eq. (4) and (5) may be implemented by a look-up table. In some embodiments, to reduce the memory required for storing the look-up table, the diff value (difference between maximum and minimum values) and the parameter α are expressed by an exponential notation. For example, diff is approximated with a 4-bit significant part and an exponent. Consequently, the table for 1/diff is reduced to 16 elements for 16 values of the significand as follows:

DivTable [ ]={0, 7, 6, 5, 5, 4, 4, 3, 3, 2, 2, 1, 1, 1, 1, 0} eq. (6)

This reduces the complexity of the calculation as well as the memory size required for storing the needed tables.

In some embodiments, to get more samples for calculating the CCLM model parameters α and β, the above template is extended to contain (W+H) samples for LM-T mode, the left template is extended to contain (H+W) samples for LM-L mode. For LM-LT mode, both the extended left template and the extended above templates are used to calculate the linear model coefficients.

To match the chroma sample locations for 4:2:0 video sequences, two types of down-sampling filters are applied to luma samples to achieve 2 to 1 down-sampling ratio in both horizontal and vertical directions. The selection of down-sampling filter is specified by a sequence parameter set (SPS) level flag. The two down-sampling filters are as follows, which correspond to “type-0” and “type-2” content, respectively.

$${rec}_{L}^{′} ( i , j ) = [ {rec}_{L} ( 2 i - 1 , 2 j - 1 ) + 2 j - 1 ) + 2 * {rec}_{L} ( 2 i - 1 , 2 j - 1 ) + {rec}_{L} ( 2 i + 1 , 2 j - 1 ) + {rec}_{L} ( 2 i - 1 , 2 j ) + {rec}_{L} ( 2 i + 1 , 2 j ) + 4 ] ≫ 3 \qquad eq . ( 7 )$$

$${rec}_{L}^{′} ( i , j ) = [ {rec}_{L} ( 2 i , 2 j - 1 ) + {rec}_{L} ( 2 i - 1 , 2 j ) + 4 * {rec}_{L} ( 2 i , 2 j ) + {rec}_{L} ( 2 i + 1 , 2 j ) + {rec}_{L} ( 2 i , 2 j + 1 ) + 4 ] ≫ 3 \qquad eq . ( 8 )$$

In some embodiments, only one luma line (general line buffer in intra prediction) is used to make the down-sampled luma samples when the upper reference line is at the CTU boundary.

In some embodiments, the α and β parameters computation is performed as part of the decoding process, and is not just as an encoder search operation. As a result, no syntax is used to convey the α and β values to decoder.

For chroma intra mode coding, a total of 8 intra modes are allowed. Those modes include five traditional intra modes and three cross-component linear model modes (LM_LA, LM_A, and LM_L). Chroma mode coding directly depends on the intra prediction mode of the corresponding luma block. Chroma (intra) mode signaling and corresponding luma intra prediction modes are according to the following table:

| Chroma Intra | Corresponding Luma Intra | | | | |
|---|---|---|---|---|---|
| Prediction | Prediction Mode | | | | |
| Mode | 0 | 50 | 18 | 1 | X (0 ≤ X ≤ 66) |
| 0 | 66 | 0 | 0 | 0 | 0 |
| 1 | 50 | 66 | 50 | 50 | 50 |
| 2 | 18 | 18 | 66 | 18 | 18 |
| 3 | 1 | 1 | 1 | 66 | 1 |
| 4 | 0 | 50 | 18 | 1 | X |
| 5 | 81 | 81 | 81 | 81 | 81 |
| 6 | 82 | 82 | 82 | 82 | 82 |
| 7 | 83 | 83 | 83 | 83 | 83 |

Since separate block partitioning structure for luma and chroma components is enabled in I slices, one chroma block may correspond to multiple luma blocks. Therefore, for Chroma DM (**what is DM**) mode, the intra prediction mode of the corresponding luma block covering the center position of the current chroma block is directly inherited.

A single unified binarization table (mapping to bin string) is used for chroma intra prediction mode according to the following table:

| Chroma intra | |
|---|---|
| prediction mode | Bin string |
| 4 | 00 |
| 0 | 0100 |
| 1 | 0101 |
| 2 | 0110 |
| 3 | 0111 |
| 5 | 10 |
| 6 | 110 |
| 7 | 111 |

In the Table, the first bin indicates whether it is regular (0) or LM mode (1). If it is LM mode, then the next bin indicates whether it is LM_CHROMA (0) or not. If it is not LM_CHROMA, next 1 bin indicates whether it is LM_L (0) or LM_A (1). For this case, when sps_cclm_enabled_flag is 0, the first bin of the binarization table for the corresponding intra_chroma_pred_mode can be discarded prior to the entropy coding. Or, in other words, the first bin is inferred to be 0 and hence not coded. This single binarization table is used for both sps_cclm_enabled_flag equal to 0 and 1 cases. The first two bins in the table are context coded with its own context model, and the rest bins are bypass coded.

In addition, in order to reduce luma-chroma latency in dual tree, when the 64×64 luma coding tree node is not split (and ISP is not used for the 64×64 CU) or partitioned with QT, the chroma CUs in 32×32/32×16 chroma coding tree node are allowed to use CCLM in the following way:
If the 32×32 chroma node is not split or partitioned with QT split, all chroma CUs in the 32×32 node can use CCLM
If the 32×32 chroma node is partitioned with Horizontal BT, and the 32×16 child node does not split or uses Vertical BT split, all chroma CUs in the 32×16 chroma node can use CCLM.
In all the other luma and chroma coding tree split conditions, CCLM is not allowed for chroma CU.

### II. Multi-Model CCLM Combined Prediction

To improve coding efficiency of CCLM, some embodiments of the disclosure provide a method to apply multi-model cross-component linear model prediction with prediction combination for Skip, Merge, Direct, Inter modes, and/or IBC modes. In some embodiments, LM parameters from different types of CCLM are derived. Chroma prediction is the prediction combination of these models as shown in the following equation: (n indicate different models)

$${pred}_{C} ( i , j ) = {\sum }_{n = 1}^{N} {w}_{n} ( i , j ) \cdot ( {α}_{n} \cdot {rec}_{L}^{′} ( i , j ) ) + {β}_{n} ) \qquad eq . ( 9 )$$

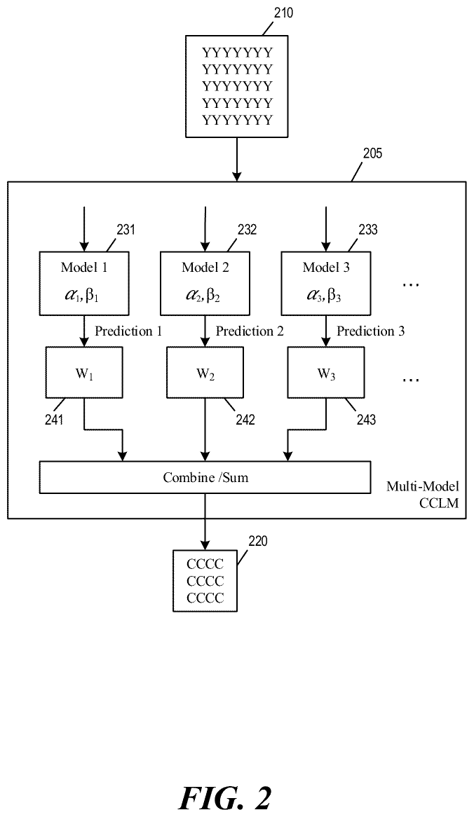

FIG. 2 conceptually illustrates multi-model chroma prediction for a block of pixels. As illustrated, eq. (9) is implemented by a multi-model chroma prediction module 205, which is applied to luma samples 210 of a current block 200 to generate predicted chroma samples 220. The multi-model chroma prediction module 205 includes linear models 231, 232, and 233 (models 1-3), each linear model is based on a parameter α and a parameter β. Each linear model generates its own model prediction (predictions 1-3) based on the luma samples 210. The model predictions of the different models 231-233 are respectively weighted by weighting factors 241-243 (W₁, W₂, W₃) and combined to produce predicted chroma samples 220. In some embodiments, two separate multi-model chroma prediction modules are used to produce chroma prediction samples for Cr and Cb components, each chroma component having its own set of linear models.

In some embodiments, different sets of LM parameters (α and β) from the three types of CCLM modes (LM-LT, LM-L, LM-T) are derived and used as part of the multi-model chroma prediction. A final chroma prediction is the weighted combination of these three models as shown in the following equation:

$${pred}_{C} ( i , j ) = p ( i , j ) \cdot ( {α}_{LT} \cdot {rec}_{L}^{′} ( i , j ) + {β}_{LT} ) + q ( i , j ) \cdot ( {α}_{L} \cdot {rec}_{L}^{′} ( i , j ) + {β}_{L} ) + r ( i , j ) \cdot ( {α}_{T} \cdot {rec}_{L}^{′} ( i , j ) + {β}_{T} ) \qquad eq . ( 10 )$$

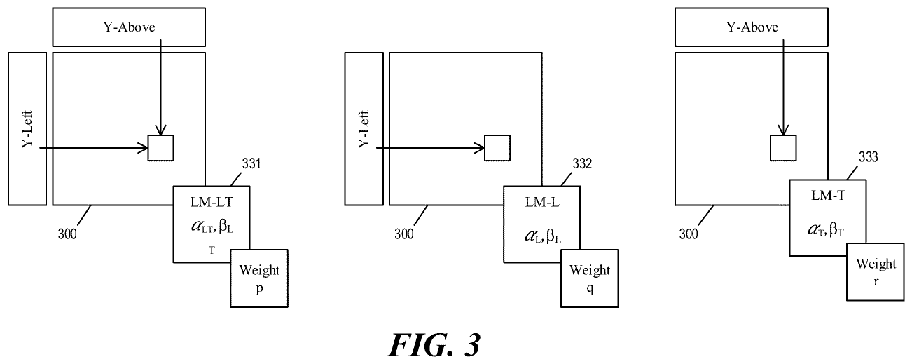

The weighting factors p, q, and r are respectively the weighting factors for LM-LT mode prediction, LM-L mode prediction, and LM-T mode prediction. FIG. 3 conceptually illustrates the construction of chroma prediction linear models for the three CCLM modes. Specifically, the figure shows that the reconstructed luma samples (Y-above) above the current block 300 and the reconstructed luma samples left (Y-left) of the current block 300 are used to construct three linear models 331-333. The linear model 331 is a LM-LT model derived from Y-above and Y-left. The linear model 332 is a LM-L model 332 derived from Y-left. The linear model 333 is a LM-T model derived from Y-above. Outputs of linear models 331-333 are weighted by weighting factors p, q, and r respectively.

In some embodiments, the weighting values p, q, and r in eq. (10) can be different for different sample positions in the block. For example, if one block is split to 4 regions, the p, q, and r values can be different for sample positions in those 4 different regions according to the following:

| | |
|---|---|
| region 1: | region 2: |
| p = 1/2, q = 1/4, r = 1/4 | p = 1/2, q = 0, r = 1/2 |
| region 3: | region 4: |
| p = 1/2, q = 1/2, r = 0 | p = 1, q = 0, r = 0 |

In some embodiments, weighting factors p, q, and r can be determined based on whether left and/or above boundaries are available or not. For example, if only the left boundary is available, then p and r are set to 0 or almost 0. If both (above and left) templates are available, then p, q and r are all set to non-zero.

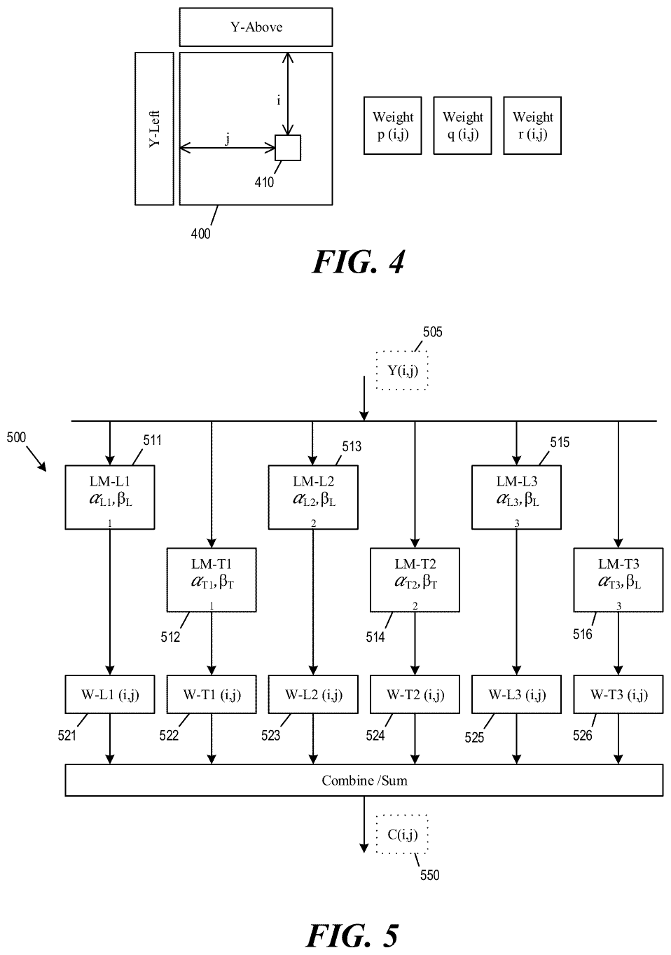

In some embodiments, values of the weighting factors are calculated based on the distances to the top (j) and left (i) boundaries (from the sample being predicted.) FIG. 4 conceptually illustrates distances j and i to the top and the left from a position 410 in the current block 400. The distances i and j are used to determine the values of the weighting factors p, q, and r for that position 410. In some embodiments, values of the weighting factors can be calculated as:

$$q ( i , j ) = r ( i , j ) = \frac{j}{i + j} , p ( i , j ) = 0 \qquad eq . ( 11 )$$

In some embodiments, values of the weighting factors can be calculated as

$$q ( i , j ) = ( A \cdot \frac{W - i}{W} + B \cdot \frac{j}{H} ) , r ( i , j ) = ( A \cdot \frac{i}{W} + B \cdot \frac{H - i}{H} ) \qquad eq . ( 12 )$$

H and W are height and width of the current block. A and B can be constant values (e.g., A=B=0.5). A and B can also be parameters that are derived from H and W, e.g., A=W/(W+H) and B=H/(W+H); or A=H/(W+H) and B=W/(W+H). Generally, position-based weighting factors can be used to implement a multi-model chroma prediction based on multiple LM-T models and/or multiple LM-L models. Specifically, the combined chroma prediction is the weighted sum of the outputs of multiple different LM-T and LM-L models, with each linear model being weighted based on the position (i and j) of the predicted sample (or current sample).

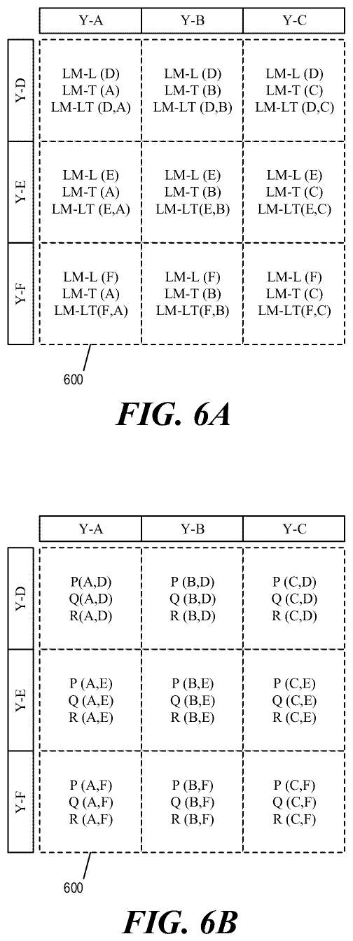

FIG. 5 conceptually illustrates multi-model chroma prediction with multiple LM-T and/or multiple LM-L models. As illustrated, a multi-model chroma prediction module 500 receives luma samples 505 and produces predicted chroma samples 520. Multiple LM-L models 511, 513, 515 and multiple LM-T models 512, 514, 516 are used to generate model predictions based on the luma samples 505. Each linear model 511-516 has a corresponding weighting factor 521-526. The values of the weighting factors may be determined based on the positions of the predicted samples by an equation similar to eq. (11), eq. (12), or another equation. The weighted model predictions are combined to produce the predicted chroma samples 550.

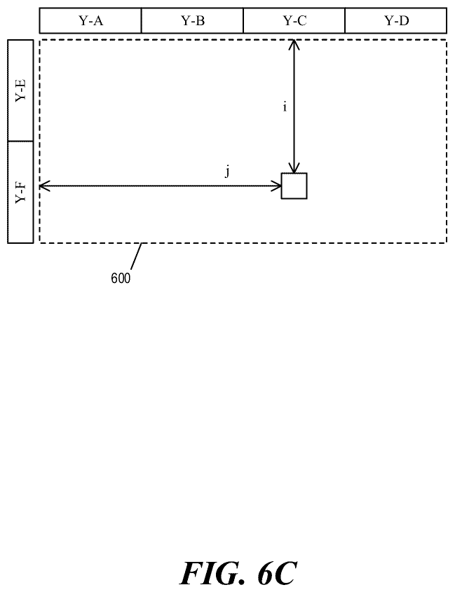

In some embodiments, the different LM-T models may correspond to different horizontal positions and the different LM-L models may correspond to different vertical positions. FIGS. 6A-B conceptually illustrate using multiple linear models for chroma prediction based on the position of the predicted sample. As illustrated, a current block 600 has above neighboring luma samples that are divided into regions Y-A, Y-B, and Y-C, as well as left neighboring luma samples that are divided into regions Y-D, Y-E, and Y-F. FIG. 6A illustrates luma samples of different regions being used to derive different linear models. For example, predicted samples in positions aligned with Y-A and Y-D may use a LM-T model derived from Y-A, or a LM-L model derived from Y-D, or a LM-LT model derived from Y-A and Y-D; predicted samples in positions aligned with Y-C and Y-E may use a LM-T model derived from Y-C, or a LM-L model derived from Y-E, or a LM-LT model derived from Y-C and Y-E. These different linear models may be used in combination to produce the predicted chroma samples, with the prediction outputs of the different models being weighted differently based on the positions of the samples being predicted.

In some embodiments, a current block may be divided into multiple regions for purpose of chroma prediction, with different regions of the current block each having its own method of combining predictions of different models. A sample within a given region would use the method of chroma prediction combination of that region. FIG. 6B conceptually illustrates different regions of the current block 600 using different methods of chroma prediction combination. In the example, different regions of the current block use different sets of weight factors for LM-LT, LM-T, and LM-L (or P, Q, and R). Thus, a region aligned with Y-A and Y-D has P, Q, and R weighting factors that are specific to the (A,D) region, while a region aligned with Y-C and Y-E has P, Q, and R weighting factors that are specific to the (C,E) region, etc. In some embodiments, the chroma prediction combination method of one region of the current block may be configured to blend in prediction results of linear models of other regions, or other types of prediction results (e.g., inter or intra prediction). In some other embodiments (as shown in FIG. 6C), a current block 600 has above neighboring luma samples that are divided into regions Y-A, Y-B, Y-C and Y-D, as well as left neighboring luma samples that are divided into regions Y-E, and Y-F. Different regions of the current block 600 in FIG. 6C uses different methods of chroma prediction combination.

In some embodiments, multiple different models are derived and blending of the multiple different models is performed according to a similarity measure of boundary samples at the top and left CU boundaries and/or some pre-defined weights. For example, the model prediction from a LT-T model may be weighed less if there is a low similarity measure between the neighboring samples above the current block and the samples along the top boundary of the current block.

In some embodiment, multi-model prediction is computed by combining normal intra mode and CCLM mode, with different weights assigned to the prediction of each mode. For example, for samples close to the left and/or top boundary, the normal intra mode prediction may be assigned the larger weight in the multi-model prediction; otherwise, the CCLM mode prediction may be assigned the larger weight. In some of these embodiments, the weights assigned to normal intra mode prediction and CCLM mode prediction are derived from luma residual magnitude. For example, if the luma residual magnitude is small, normal intra mode prediction may be assigned the larger weight; otherwise, CCLM mode prediction may be assigned the larger weight.

In some embodiments, multi-model prediction is computed by combining predictions of the normal inter mode and the CCLM mode. In some embodiments, the weights assigned to the normal inter mode prediction and the CCLM mode prediction are derived from luma residual magnitude. In some embodiments, prediction refinement is derived using CCLM and added to chroma prediction.

The foregoing proposed method can be implemented in encoders and/or decoders. For example, the proposed method can be implemented in a inter prediction module and/or intra block copy prediction module of an encoder, and/or a inter prediction module (and/or intra block copy prediction module) of a decoder.

### III. Example Video Encoder

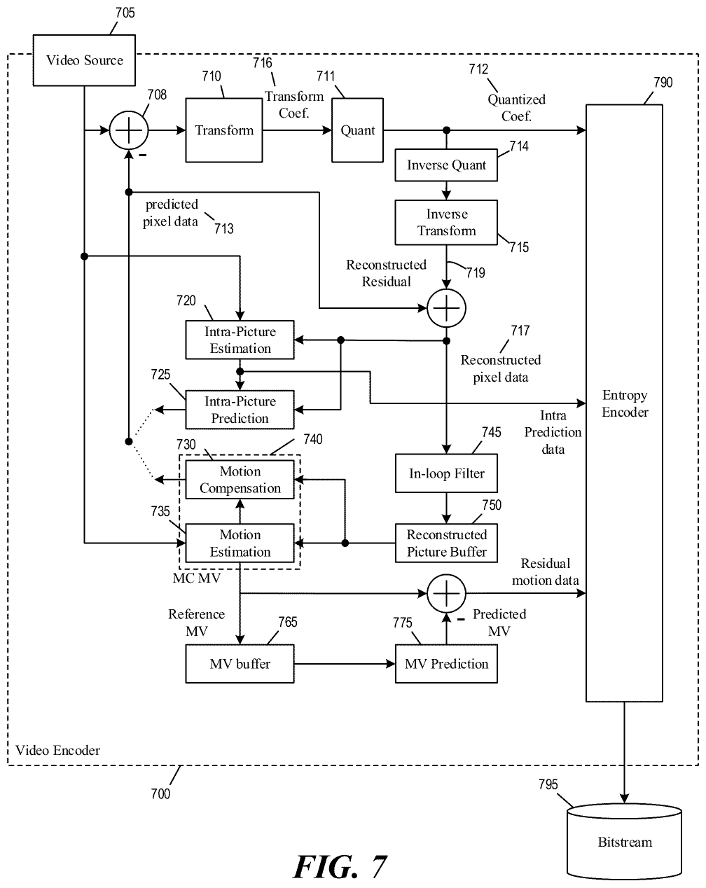

FIG. 7 illustrates an example video encoder 700 that may implement chroma prediction. As illustrated, the video encoder 700 receives input video signal from a video source 705 and encodes the signal into bitstream 795. The video encoder 700 has several components or modules for encoding the signal from the video source 705, at least including some components selected from a transform module 710, a quantization module 711, an inverse quantization module 714, an inverse transform module 715, an intra-picture estimation module 720, an intra-prediction module 725, a motion compensation module 730, a motion estimation module 735, an in-loop filter 745, a reconstructed picture buffer 750, a MV buffer 765, and a MV prediction module 775, and an entropy encoder 790. The motion compensation module 730 and the motion estimation module 735 are part of an inter-prediction module 740.

In some embodiments, the modules 710-790 are modules of software instructions being executed by one or more processing units (e.g., a processor) of a computing device or electronic apparatus. In some embodiments, the modules 710-790 are modules of hardware circuits implemented by one or more integrated circuits (ICs) of an electronic apparatus. Though the modules 710-790 are illustrated as being separate modules, some of the modules can be combined into a single module.

The video source 705 provides a raw video signal that presents pixel data of each video frame without compression. A subtractor 708 computes the difference between the raw video pixel data of the video source 705 and the predicted pixel data 713 from the motion compensation module 730 or intra-prediction module 725. The transform module 710 converts the difference (or the residual pixel data or residual signal 708) into transform coefficients (e.g., by performing Discrete Cosine Transform, or DCT). The quantization module 711 quantizes the transform coefficients into quantized data (or quantized coefficients) 712, which is encoded into the bitstream 795 by the entropy encoder 790.

The inverse quantization module 714 de-quantizes the quantized data (or quantized coefficients) 712 to obtain transform coefficients, and the inverse transform module 715 performs inverse transform on the transform coefficients to produce reconstructed residual 719. The reconstructed residual 719 is added with the predicted pixel data 713 to produce reconstructed pixel data 717. In some embodiments, the reconstructed pixel data 717 is temporarily stored in a line buffer (not illustrated) for intra-picture prediction and spatial MV prediction. The reconstructed pixels are filtered by the in-loop filter 745 and stored in the reconstructed picture buffer 750. In some embodiments, the reconstructed picture buffer 750 is a storage external to the video encoder 700. In some embodiments, the reconstructed picture buffer 750 is a storage internal to the video encoder 700.

The intra-picture estimation module 720 performs intra-prediction based on the reconstructed pixel data 717 to produce intra prediction data. The intra-prediction data is provided to the entropy encoder 790 to be encoded into bitstream 795. The intra-prediction data is also used by the intra-prediction module 725 to produce the predicted pixel data 713.

The motion estimation module 735 performs inter-prediction by producing MVs to reference pixel data of previously decoded frames stored in the reconstructed picture buffer 750. These MVs are provided to the motion compensation module 730 to produce predicted pixel data.

Instead of encoding the complete actual MVs in the bitstream, the video encoder 700 uses MV prediction to generate predicted MVs, and the difference between the MVs used for motion compensation and the predicted MVs is encoded as residual motion data and stored in the bitstream 795.

The MV prediction module 775 generates the predicted MVs based on reference MVs that were generated for encoding previously video frames, i.e., the motion compensation MVs that were used to perform motion compensation. The MV prediction module 775 retrieves reference MVs from previous video frames from the MV buffer 765. The video encoder 700 stores the MVs generated for the current video frame in the MV buffer 765 as reference MVs for generating predicted MVs.

The MV prediction module 775 uses the reference MVs to create the predicted MVs. The predicted MVs can be computed by spatial MV prediction or temporal MV prediction. The difference between the predicted MVs and the motion compensation MVs (MC MVs) of the current frame (residual motion data) are encoded into the bitstream 795 by the entropy encoder 790.

The entropy encoder 790 encodes various parameters and data into the bitstream 795 by using entropy-coding techniques such as context-adaptive binary arithmetic coding (CABAC) or Huffman encoding. The entropy encoder 790 encodes various header elements, flags, along with the quantized transform coefficients 712, and the residual motion data as syntax elements into the bitstream 795. The bitstream 795 is in turn stored in a storage device or transmitted to a decoder over a communications medium such as a network.

The in-loop filter 745 performs filtering or smoothing operations on the reconstructed pixel data 717 to reduce the artifacts of coding, particularly at boundaries of pixel blocks. In some embodiments, the filtering operation performed includes sample adaptive offset (SAO). In some embodiment, the filtering operations include adaptive loop filter (ALF).

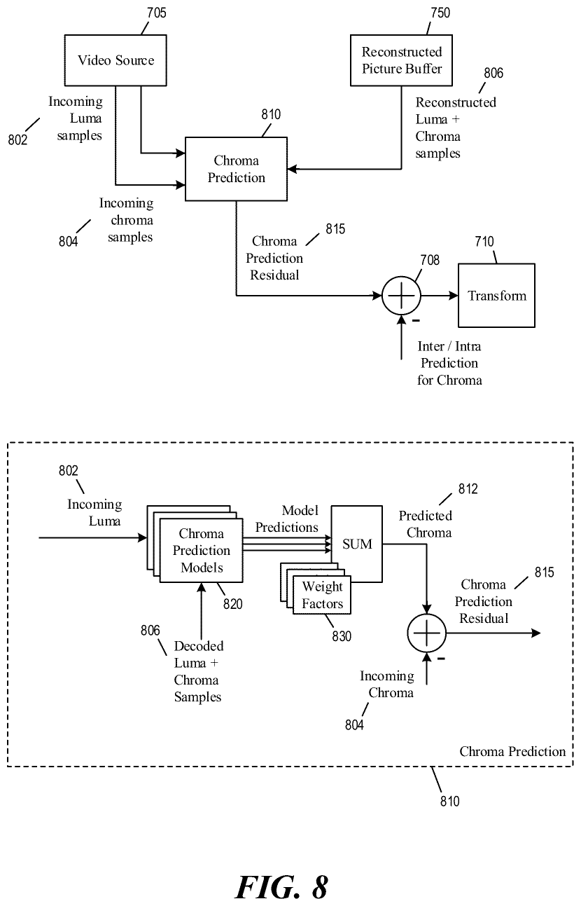

FIG. 8 illustrates portions of the video encoder 700 that implement multi-model chroma prediction. As illustrated, the video source 705 provides incoming luma and chroma samples 802 and 804, while the reconstructed picture buffer 750 provides reconstructed luma and chroma samples. The incoming luma samples 802 are used to generate predicted chroma samples 812. The predicted chroma samples 812 are then used to produce the chroma prediction residual 815 by subtracting the incoming chroma samples 804. The chroma prediction residual signal 815 is encoded (transformed, inter/intra predicted, etc.) in place of regular chroma samples.

The chroma prediction module 810 uses multiple chroma prediction models 820 to produce the predicted chroma samples 812 based on the incoming luma samples 802. Each of the multiple chroma prediction models 820 outputs a model prediction based on the incoming luma samples 802. The model predictions of the different chroma prediction models 820 are weighted by corresponding weight factors 830 and summed to produce the predicted chroma samples 812. The values of the weight factors 830 may vary with the position of the current sample in the current block.

The chroma prediction models 820 are derived from reconstructed chroma and luma samples 806 retrieved from the reconstructed picture buffer 750, particularly the reconstructed luma and chroma samples that neighbors the top and left boundaries of the current block. In some embodiments, the chroma prediction models 820 may include LM-L, LM-T, and LM-LT linear models. In some embodiments, the chroma prediction models 820 may include multiple LM-L models and multiple LM-T models.

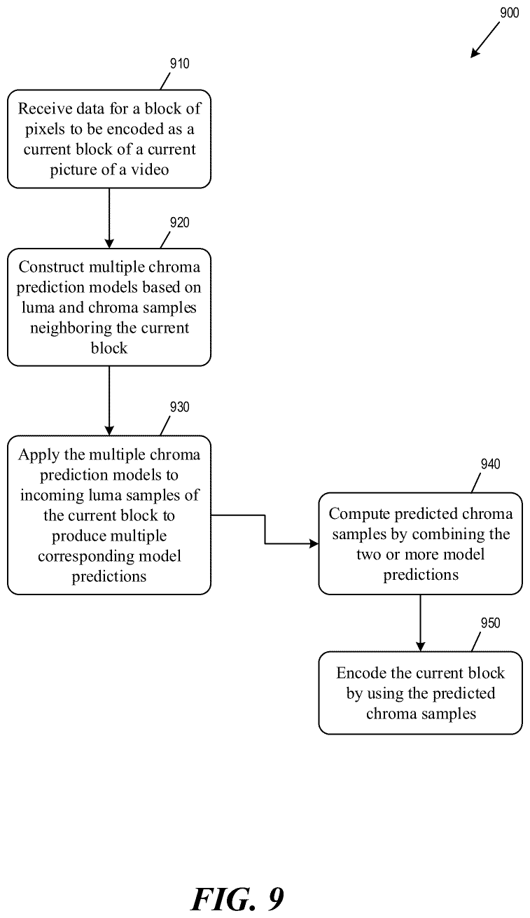

FIG. 9 conceptually illustrates a process 900 for using multi-model chroma prediction to encode a block of pixels. In some embodiments, one or more processing units (e.g., a processor) of a computing device implementing the encoder 700 performs the process 900 by executing instructions stored in a computer readable medium. In some embodiments, an electronic apparatus implementing the encoder 700 performs the process 900.

The encoder receives (at block 910) data for a block of pixels to be encoded as a current block in a current picture of a video.

The encoder constructs (at block 920) two or more chroma prediction models based on luma and chroma samples neighboring the current block. The two or more chroma prediction models may include a LM-T model that is derived based on neighboring reconstructed luma samples above the current block, a LM-L model that is derived based on neighboring reconstructed luma samples left of the current block, and a LM-LT model that is derived based on neighboring reconstructed luma samples above the current block and left of the current block. In some embodiments, the two or more chroma prediction models includes multiple LM-T models and/or multiple LM-L models.

The encoder applies (at block 930) the two or more chroma prediction models to incoming luma samples of the current block to produce two or more corresponding model predictions.

The encoder computes (at block 940) predicted chroma samples by combining the two or more model predictions. The predicted chroma samples may be computed as a weighted sum of the two or more model predictions. In some embodiments, each of the two or more model predictions is weighted based on a position of the predicted sample (or current sample) in the current block. In some embodiments, the two or more model predictions are weighted according to distances from the predicted sample to top and left boundaries of the current block. In some embodiments, the two or more model predictions are weighted according to corresponding two or more weighting factors. In some embodiments, each of the two or more model predictions is weighted based on a similarity measure between boundary samples of the current block and reconstructed neighboring samples of the current block.

In some embodiments, the predicted chroma samples in different regions of the current block are computed by different fusion methods. For example, the corresponding two or more weighting factors may be assigned different values in different regions of the current block. The predicted chroma samples in different regions of the current block may be computed by different sets of linear models.

In some embodiments, the predicted chroma samples is computed by further combining inter-prediction or intra-prediction of the current block with the two or more model predictions produced by the two or more chroma prediction models.

The encoder encodes (at block 950) the current block by using the predicted chroma samples. Specifically, the predicted chroma samples are used to produce the chroma prediction residual by subtracting the incoming actual chroma samples. The chroma prediction residual signal is encoded (transformed, inter/intra predicted, etc.) into bitstream.

### IV. Example Video Decoder

In some embodiments, an encoder may signal (or generate) one or more syntax element in a bitstream, such that a decoder may parse said one or more syntax element from the bitstream.

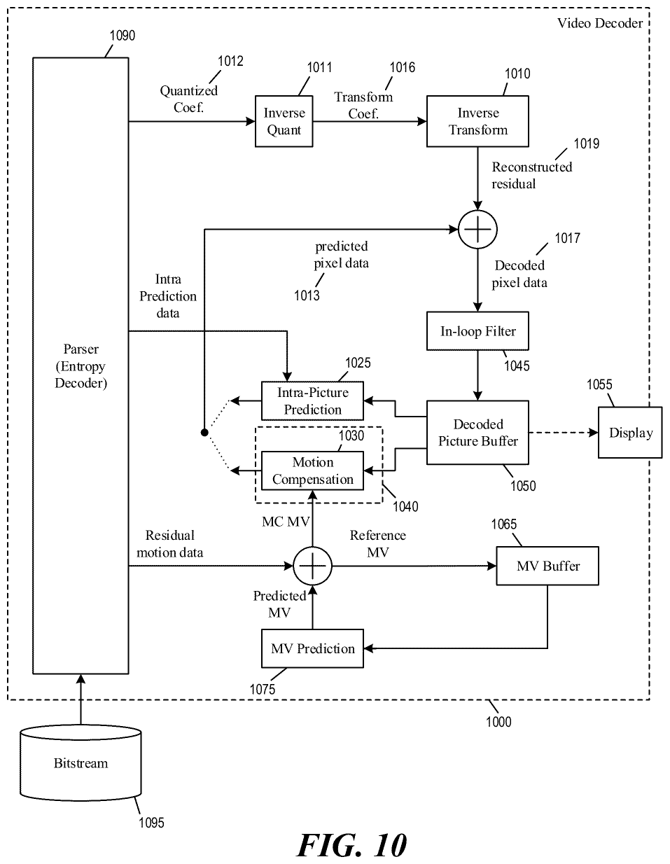

FIG. 10 illustrates an example video decoder 1000 that may implement chroma prediction. As illustrated, the video decoder 1000 is an image-decoding or video-decoding circuit that receives a bitstream 1095 and decodes the content of the bitstream into pixel data of video frames for display. The video decoder 1000 has several components or modules for decoding the bitstream 1095, including some components selected from an inverse quantization module 1011, an inverse transform module 1010, an intra-prediction module 1025, a motion compensation module 1030, an in-loop filter 1045, a decoded picture buffer 1050, a MV buffer 1065, a MV prediction module 1075, and a parser 1090. The motion compensation module 1030 is part of an inter-prediction module 1040.

In some embodiments, the modules 1010-1090 are modules of software instructions being executed by one or more processing units (e.g., a processor) of a computing device. In some embodiments, the modules 1010-1090 are modules of hardware circuits implemented by one or more ICs of an electronic apparatus. Though the modules 1010-1090 are illustrated as being separate modules, some of the modules can be combined into a single module.

The parser 1090 (or entropy decoder) receives the bitstream 1095 and performs initial parsing according to the syntax defined by a video-coding or image-coding standard. The parsed syntax element includes various header elements, flags, as well as quantized data (or quantized coefficients) 1012. The parser 1090 parses out the various syntax elements by using entropy-coding techniques such as context-adaptive binary arithmetic coding (CABAC) or Huffman encoding.

The inverse quantization module 1011 de-quantizes the quantized data (or quantized coefficients) 1012 to obtain transform coefficients, and the inverse transform module 1010 performs inverse transform on the transform coefficients 1016 to produce reconstructed residual signal 1019. The reconstructed residual signal 1019 is added with predicted pixel data 1013 from the intra-prediction module 1025 or the motion compensation module 1030 to produce decoded pixel data 1017. The decoded pixels data are filtered by the in-loop filter 1045 and stored in the decoded picture buffer 1050. In some embodiments, the decoded picture buffer 1050 is a storage external to the video decoder 1000. In some embodiments, the decoded picture buffer 1050 is a storage internal to the video decoder 1000.

The intra-prediction module 1025 receives intra-prediction data from bitstream 1095 and according to which, produces the predicted pixel data 1013 from the decoded pixel data 1017 stored in the decoded picture buffer 1050. In some embodiments, the decoded pixel data 1017 is also stored in a line buffer (not illustrated) for intra-picture prediction and spatial MV prediction.

In some embodiments, the content of the decoded picture buffer 1050 is used for display. A display device 1055 either retrieves the content of the decoded picture buffer 1050 for display directly, or retrieves the content of the decoded picture buffer to a display buffer. In some embodiments, the display device receives pixel values from the decoded picture buffer 1050 through a pixel transport.

The motion compensation module 1030 produces predicted pixel data 1013 from the decoded pixel data 1017 stored in the decoded picture buffer 1050 according to motion compensation MVs (MC MVs). These motion compensation MVs are decoded by adding the residual motion data received from the bitstream 1095 with predicted MVs received from the MV prediction module 1075.

The MV prediction module 1075 generates the predicted MVs based on reference MVs that were generated for decoding previous video frames, e.g., the motion compensation MVs that were used to perform motion compensation. The MV prediction module 1075 retrieves the reference MVs of previous video frames from the MV buffer 1065. The video decoder 1000 stores the motion compensation MVs generated for decoding the current video frame in the MV buffer 1065 as reference MVs for producing predicted MVs.

The in-loop filter 1045 performs filtering or smoothing operations on the decoded pixel data 1017 to reduce the artifacts of coding, particularly at boundaries of pixel blocks. In some embodiments, the filtering operation performed includes sample adaptive offset (SAO). In some embodiment, the filtering operations include adaptive loop filter (ALF).

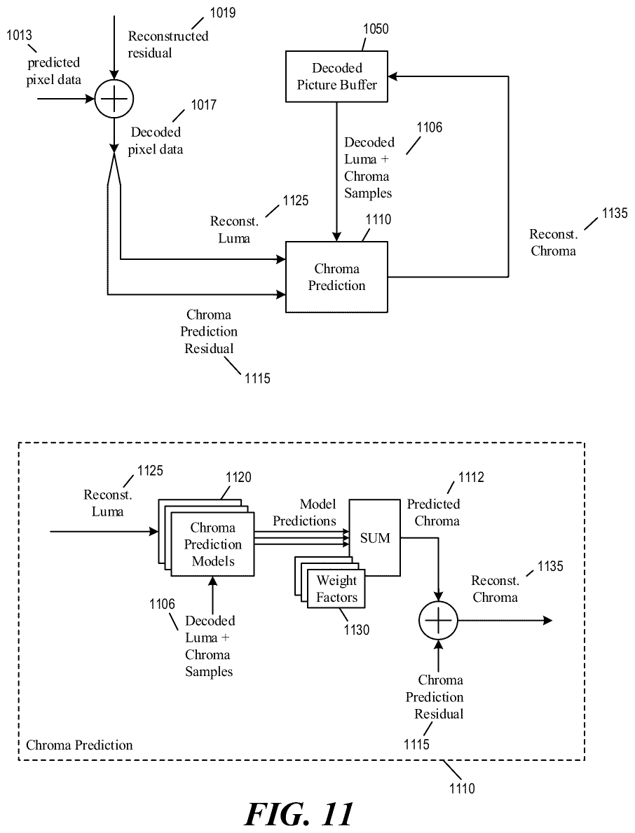

FIG. 11 illustrates portions of the video decoder 1000 that implement multi-model chroma prediction. As illustrated, the decoded picture buffer 1050 provides decoded luma and chroma samples to a chroma prediction module 1110, which produces reconstructed chroma samples 1135 for display or output by predicting chroma samples based on luma samples.

The chroma prediction module 1110 receives the decoded pixel data 1017, which includes reconstructed luma samples 1125 and chroma prediction residual 1115. The chroma prediction module 1110 uses the reconstructed luma samples 1125 to produce predicted chroma samples 1112. The predicted chroma samples 1112 are then added with the chroma prediction residual 1115 to produce the reconstructed chroma samples 1135. The reconstructed chroma samples 1135 are then stored in the decoded picture buffer 1050 for display and for reference by subsequent blocks and pictures.

The chroma prediction module 1110 uses multiple chroma prediction models 1120 to produce the predicted chroma samples 1112 based on the reconstructed luma samples 1125. Each of the multiple chroma prediction models 1120 outputs a model prediction based on the reconstructed luma samples 1125. The model predictions of the different chroma prediction models 1120 are weighted by corresponding weight factors 1130 and summed to produce the predicted chroma samples 1112. The values of the weight factors 1130 may vary with the position of the predicted sample (or current sample) in the current block.

The multiple chroma prediction models 1120 are derived from decoded chroma and luma samples 1106 retrieved from the decoded picture buffer 1050, particularly the reconstructed luma and chroma samples neighboring the top and left boundaries of the current block. In some embodiments, the multiple chroma prediction models 1120 may include LM-L, LM-T, and LM-LT linear models. In some embodiments, the chroma prediction models 1120 may include multiple LM-L models and multiple LM-T models.

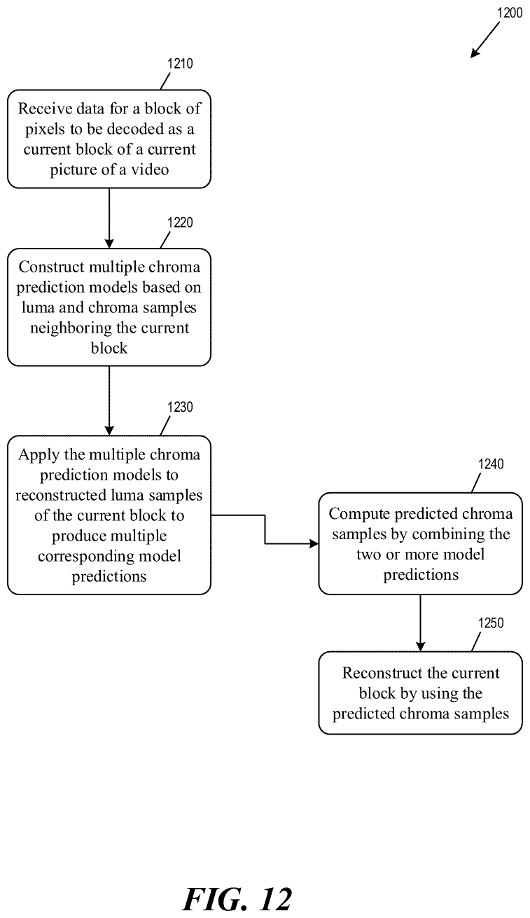

FIG. 12 conceptually illustrates a process 1200 for using multi-model chroma prediction to decode a block of pixels. In some embodiments, one or more processing units (e.g., a processor) of a computing device implementing the decoder 700 performs the process 1200 by executing instructions stored in a computer readable medium. In some embodiments, an electronic apparatus implementing the decoder 700 performs the process 1200.

The decoder receives (at block 1210) data for a block of pixels to be decoded as a current block in a current picture of a video.

The decoder constructs (at block 1220) two or more chroma prediction models based on luma and chroma samples neighboring the current block. The two or more chroma prediction models may include a LM-T model that is derived based on neighboring reconstructed luma samples above the current block, a LM-L model that is derived based on neighboring reconstructed luma samples left of the current block, and/or a LM-LT model that is derived based on neighboring reconstructed luma samples above the current block and left of the current block. In some embodiments, the two or more chroma prediction models includes multiple LM-T models and/or multiple LM-L models.

The decoder applies (at block 1230) the two or more chroma prediction models to reconstructed luma samples of the current block to produce two or more corresponding model predictions.

The decoder computes (at block 1240) predicted chroma samples by combining the two or more model predictions. The predicted chroma samples may be computed as a weighted sum of the two or more model predictions. In some embodiments, each of the two or more model predictions is weighted based on a position of the predicted sample in the current block. In some embodiments, the two or more model predictions are weighted according to distances from the predicted sample to top and left boundaries of the current block. In some embodiments, the two or more model predictions are weighted according to corresponding two or more weighting factors. In some embodiments, each of the two or more model predictions is weighted based on a similarity measure between boundary samples of the current block and reconstructed neighboring samples of the current block.

In some embodiments, the predicted chroma samples in different regions of the current block are computed by different fusion methods. For example, the corresponding two or more weighting factors may be assigned different values in different regions of the current block. The predicted chroma samples in different regions of the current block may be computed by different sets of linear models.

In some embodiments, the predicted chroma samples is computed by further combining inter-prediction or intra-prediction of the current block with the two or more model predictions produced by the two or more chroma prediction models.

The decoder reconstructs (at block 1250) the current block by using the predicted chroma samples. Specifically, the predicted chroma samples added with the chroma prediction residual to produce reconstructed chroma samples. The reconstructed chroma samples are provided for display and/stored for reference by subsequent blocks and pictures.

### V. Example Electronic System

Many of the above-described features and applications are implemented as software processes that are specified as a set of instructions recorded on a computer readable storage medium (also referred to as computer readable medium). When these instructions are executed by one or more computational or processing unit(s) (e.g., one or more processors, cores of processors, or other processing units), they cause the processing unit(s) to perform the actions indicated in the instructions. Examples of computer readable media include, but are not limited to, CD-ROMs, flash drives, random-access memory (RAM) chips, hard drives, erasable programmable read only memories (EPROMs), electrically erasable programmable read-only memories (EEPROMs), etc. The computer readable media does not include carrier waves and electronic signals passing wirelessly or over wired connections.

In this specification, the term “software” is meant to include firmware residing in read-only memory or applications stored in magnetic storage which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the present disclosure. In some embodiments, the software programs, when installed to operate on one or more electronic systems, define one or more specific machine implementations that execute and perform the operations of the software programs.

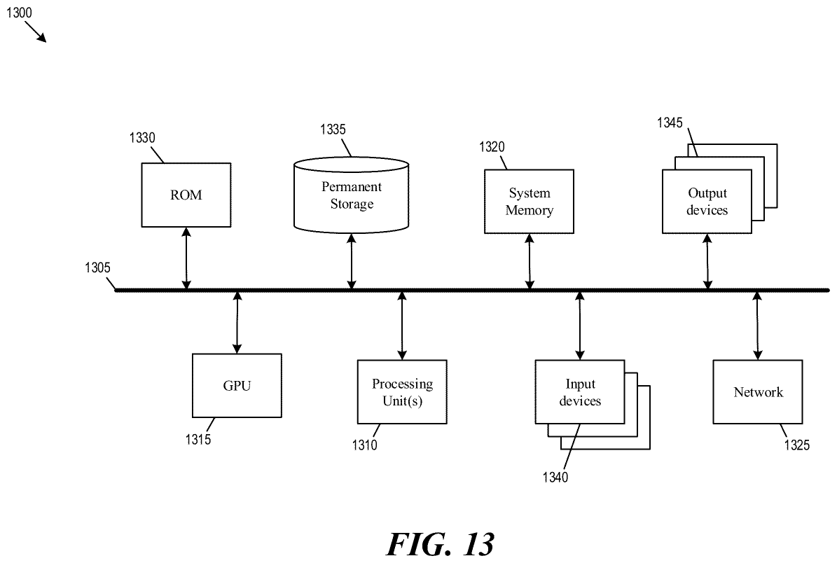

FIG. 13 conceptually illustrates an electronic system 1300 with which some embodiments of the present disclosure are implemented. The electronic system 1300 may be a computer (e.g., a desktop computer, personal computer, tablet computer, etc.), phone, PDA, or any other sort of electronic device. Such an electronic system includes various types of computer readable media and interfaces for various other types of computer readable media. Electronic system 1300 includes a bus 1305, processing unit(s) 1310, a graphics-processing unit (GPU) 1315, a system memory 1320, a network 1325, a read-only memory 1330, a permanent storage device 1335, input devices 1340, and output devices 1345.

The bus 1305 collectively represents all system, peripheral, and chipset buses that communicatively connect the numerous internal devices of the electronic system 1300. For instance, the bus 1305 communicatively connects the processing unit(s) 1310 with the GPU 1315, the read-only memory 1330, the system memory 1320, and the permanent storage device 1335.

From these various memory units, the processing unit(s) 1310 retrieves instructions to execute and data to process in order to execute the processes of the present disclosure. The processing unit(s) may be a single processor or a multi-core processor in different embodiments. Some instructions are passed to and executed by the GPU 1315. The GPU 1315 can offload various computations or complement the image processing provided by the processing unit(s) 1310.

The read-only-memory (ROM) 1330 stores static data and instructions that are used by the processing unit(s) 1310 and other modules of the electronic system. The permanent storage device 1335, on the other hand, is a read-and-write memory device. This device is a non-volatile memory unit that stores instructions and data even when the electronic system 1300 is off. Some embodiments of the present disclosure use a mass-storage device (such as a magnetic or optical disk and its corresponding disk drive) as the permanent storage device 1335.

Other embodiments use a removable storage device (such as a floppy disk, flash memory device, etc., and its corresponding disk drive) as the permanent storage device. Like the permanent storage device 1335, the system memory 1320 is a read-and-write memory device. However, unlike storage device 1335, the system memory 1320 is a volatile read-and-write memory, such a random access memory. The system memory 1320 stores some of the instructions and data that the processor uses at runtime. In some embodiments, processes in accordance with the present disclosure are stored in the system memory 1320, the permanent storage device 1335, and/or the read-only memory 1330. For example, the various memory units include instructions for processing multimedia clips in accordance with some embodiments. From these various memory units, the processing unit(s) 1310 retrieves instructions to execute and data to process in order to execute the processes of some embodiments.

The bus 1305 also connects to the input and output devices 1340 and 1345. The input devices 1340 enable the user to communicate information and select commands to the electronic system. The input devices 1340 include alphanumeric keyboards and pointing devices (also called “cursor control devices”), cameras (e.g., webcams), microphones or similar devices for receiving voice commands, etc. The output devices 1345 display images generated by the electronic system or otherwise output data. The output devices 1345 include printers and display devices, such as cathode ray tubes (CRT) or liquid crystal displays (LCD), as well as speakers or similar audio output devices. Some embodiments include devices such as a touchscreen that function as both input and output devices.

Finally, as shown in FIG. 13, bus 1305 also couples electronic system 1300 to a network 1325 through a network adapter (not shown). In this manner, the computer can be a part of a network of computers (such as a local area network (“LAN”), a wide area network (“WAN”), or an Intranet, or a network of networks, such as the Internet. Any or all components of electronic system 1300 may be used in conjunction with the present disclosure.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, many of the above-described features and applications are performed by one or more integrated circuits, such as application specific integrated circuits (ASICs) or field programmable gate arrays (FPGAs). In some embodiments, such integrated circuits execute instructions that are stored on the circuit itself. In addition, some embodiments execute software stored in programmable logic devices (PLDs), ROM, or RAM devices.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium,” “computer readable media,” and “machine readable medium” are entirely restricted to tangible, physical objects that store information in a form that is readable by a computer. These terms exclude any wireless signals, wired download signals, and any other ephemeral signals.

While the present disclosure has been described with reference to numerous specific details, one of ordinary skill in the art will recognize that the present disclosure can be embodied in other specific forms without departing from the spirit of the present disclosure. In addition, a number of the figures (including FIG. 9 and FIG. 12) conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process. Thus, one of ordinary skill in the art would understand that the present disclosure is not to be limited by the foregoing illustrative details, but rather is to be defined by the appended claims.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A video coding method comprising:
receiving data for a block of pixels to be encoded or decoded as a current block of a current picture of a video;
constructing two or more chroma prediction models based on luma and chroma samples neighboring the current block;
applying the two or more chroma prediction models to incoming or reconstructed luma samples of the current block to produce two or more model predictions;
computing predicted chroma samples by combining the two or more model predictions; and
using the predicted chroma samples to reconstruct chroma samples of the current block or to encode the current block.

2. The video coding method of claim 1, wherein the predicted chroma samples is a weighted sum of the two or more model predictions.

3. The video coding method of claim 2, wherein each of the two or more model predictions is weighted based on a position of the predicted sample in the current block.

4. The video coding method of claim 2, wherein the two or more model predictions are weighted according to distances from the predicted sample to top and left boundaries of the current block.

5. The video coding method of claim 2, wherein the two or more model predictions are weighted according to corresponding two or more weighting factors, wherein the corresponding two or more weighting factors are assigned different values in different regions of the current block.

6. The video coding method of claim 2, wherein each of the two or more model predictions is weighted based on a similarity measure between boundary samples of the current block and reconstructed neighboring samples of the current block.

7. The video coding method of claim 1, wherein the two or more chroma prediction models comprises a first linear model that is derived based on neighboring reconstructed luma samples above the current block and a second linear model that is derived based on neighboring reconstructed luma samples left of the current block.

8. The video coding method of claim 7, wherein the two or more chroma prediction models further comprises a third linear model that is derived based on neighboring reconstructed luma samples above the current block and left of the current block.

9. The video coding method of claim 1, wherein the predicted chroma samples in different regions of the current block are computed by different sets of linear models.

10. The video coding method of claim 1, wherein the two or more chroma prediction models comprises a first plurality of linear models that are derived based on neighboring reconstructed luma samples above the current block and a second plurality of linear models that are derived based on neighboring reconstructed luma samples left of the current block.

11. The video coding method of claim 1, wherein the predicted chroma samples is computed by further combining inter-prediction or intra-prediction of the current block with the two or more model predictions produced by the two or more chroma prediction models.

12. An electronic apparatus comprising:
a video coding circuit configured to perform operations comprising:
receiving data for a block of pixels to be encoded or decoded as a current block of a current picture of a video;
constructing two or more chroma prediction models based on luma and chroma samples neighboring the current block;
applying the two or more chroma prediction models to incoming or reconstructed luma samples of the current block to produce two or more model predictions;
computing predicted chroma samples by combining the two or more model predictions; and
using the predicted chroma samples to reconstruct chroma samples of the current block or to encode the current block.

13. A video decoding method comprising:
receiving data for a block of pixels to be decoded as a current block of a current picture of a video;
constructing two or more chroma prediction models based on luma and chroma samples neighboring the current block;
applying the two or more chroma prediction models to reconstructed luma samples of the current block to produce two or more model predictions;
computing predicted chroma samples by combining the two or more model predictions; and
using the predicted chroma samples to reconstruct chroma samples of the current block.

14. A video encoding method comprising:
receiving data for a block of pixels to be encoded as a current block of a current picture of a video;
constructing two or more chroma prediction models based on luma and chroma samples neighboring the current block;
applying the two or more chroma prediction models to incoming luma samples of the current block to produce two or more corresponding model predictions;
computing predicted chroma samples by combining the two or more model predictions; and
using the predicted chroma samples to encode the current block.
